(19) United States
(12) Patent Application Publication
(10) Pub. No.: US 2026/0363312 A1
(43) Pub. Date: Nov. 19, 2026

(54) ATOMIZER AND ELECTRONIC ATOMIZATION DEVICE

(71) Applicant: SMOORE INTERNATIONAL HOLDINGS LIMITED, Grand Cayman (KY)

(72) Inventor: Xuanlin WANG, Shenzhen (CN)

(73) Assignee: SMOORE INTERNATIONAL HOLDINGS LIMITED, Grand Cayman (KY)

(21) Appl. No.: 19/681,210

(22) Filed: May 19, 2026

(30) Foreign Application Priority Data
May 19, 2025 (CN) 202520988084.8

(51) Int. Cl. A24F 40/42; A24F 40/10; A24F 40/46; A24F 40/485; H05B 3/02

(52) U.S. Cl. CPC A24F 40/42; A24F 40/10; A24F 40/46; A24F 40/485; H05B 3/02; H05B 2203/021

(57) ABSTRACT

An atomizer and an electronic atomization device are provided. The atomizer includes a liquid storage assembly which includes a housing and a sealing cover arranged at an end of the housing. A liquid storage cavity is formed between the housing and the sealing cover. A heating assembly includes at least one piercing element, and the at least one piercing element is configured to pierce the pierced structure to form a liquid flowing channel in communication with the liquid storage cavity. A sealing cover is provided to seal a gap between the sealing cover and the piercing element.

### RELATED APPLICATION

The present application claims priority to Chinese Patent Application No. 202520988084.8 filed on May 19, 2025. The entire disclosure of the prior application is hereby incorporated by reference.

### TECHNICAL FIELD

This disclosure relates to the field of atomization technologies, and in particular, to an atomizer and an electronic atomization device.

### BACKGROUND

An aerosol is a colloidal dispersion system formed by solid or liquid small particles dispersed and suspended in a gas substrate. Because the aerosol may be absorbed by a human body through the respiratory system, a new alternative absorption method is provided for users. An atomizer refers to a device that forms an atomizable substrate stored therein into an aerosol by heating, ultrasound, or other methods. Atomization substrates include liquid, gel, paste, or solid aerosol generating substrates. By atomizing these substrates, inhalable aerosols can be delivered to users, to replace conventional product forms and absorption methods.

An atomizer using a pierce-type liquid storage assembly generally includes a liquid storage assembly and a piercing structure. The liquid storage assembly is configured to store an atomization substrate, and the piercing structure is configured to pierce the liquid storage assembly to cause the atomization substrate to flow out. However, due to structural defects, it is difficult for the existing atomizers using pierce-type liquid storage assemblies to effectively prevent leakage of the atomization substrate while ensuring smoothness of insertion and removal, consequently affecting the user experience and hindering further promotion and disclosure of such atomizers.

### SUMMARY

Based on this, it is necessary to provide an atomizer and an electronic atomization device for the problem of difficult removal and insertion of a liquid storage assembly and a piercing structure.

An atomizer is provided, including:
a liquid storage assembly, including a housing and a sealing cover arranged at an end of the housing, where a liquid storage cavity is formed between the housing and the sealing cover; and
a heating assembly, fitted to the end of the liquid storage assembly at which the sealing cover is arranged, where the heating assembly includes a piercing element, and the piercing element is configured to pierce the sealing cover to form fluid communication between the liquid storage cavity and the heating assembly,
a gap is provided between an outer edge of the piercing element and the sealing cover, the liquid storage assembly further includes a sealing structure, and the sealing structure seals the gap between the sealing cover and the piercing element.

In an aspect, in a direction parallel to the direction in which the piercing element pierces the sealing cover, the sealing structure and a pierced surface of the sealing cover are arranged sequentially, and the sealing structure is located at the side of the pierced surface away from the liquid storage cavity.

In an aspect, the sealing cover is provided with a communication channel, and the piercing element extends into the liquid storage cavity through the communication channel; and the communication channel is provided with an inner side wall, and the gap is formed between an outer wall of the piercing element and the inner side wall of the communication channel.

In an aspect, the sealing structure extends in the circumferential direction of the inner side wall of the communication channel to surround the piercing element.

In an aspect, a guiding surface is formed at the side of the sealing structure facing away from the liquid storage cavity; and

in an insertion direction of the piercing element, the guiding surface extends obliquely toward the liquid storage cavity from a side edge thereof connected to the inner side wall of the communication channel to a side edge thereof away from the inner side wall of the communication channel.

In an aspect, the piercing element is provided with a liquid flowing channel inside, and when the piercing element pierces the sealing cover, the liquid storage cavity and the heating assembly are in fluid communication through the liquid flowing channel.

In an aspect, a channel wall of the liquid flowing channel is provided with at least one liquid guiding groove, the at least one liquid guiding groove are spaced apart circumferentially, and each of the at least one liquid guiding groove extends in the length direction of the liquid flowing channel.

In an aspect, a piercing portion extending into the liquid flowing channel protrudes from the end portion of the piercing element inserted into the liquid storage cavity.

In an aspect, a piercing surface extending obliquely relative to an insertion direction of the piercing element is formed at the end of the piercing element inserted into the liquid storage cavity, and the piercing portion is connected to the region of the piercing surface closest to the sealing cover.

An electronic atomization device is provided, including the atomizer and a power supply component, where the power supply component is configured to supply power to the atomizer, the atomizer including:
a liquid storage assembly, including a housing and a sealing cover arranged at an end of the housing, where a liquid storage cavity is formed between the housing and the sealing cover; and
a heating assembly, fitted to the end of the liquid storage assembly at which the sealing cover is arranged, where the heating assembly includes a piercing element, and the piercing element is configured to pierce the sealing cover to form fluid communication between the liquid storage cavity and the heating assembly, where
a gap is provided between an outer edge of the piercing element and the sealing cover, the liquid storage assembly further includes a sealing structure, and the sealing structure seals the gap between the sealing cover and the piercing element.

In an aspect, in a direction parallel to the direction in which the piercing element pierces the sealing cover, the sealing structure and a pierced surface of the sealing cover are arranged sequentially, and the sealing structure is located at the side of the pierced surface away from the liquid storage cavity.

In an aspect, the sealing cover is provided with a communication channel, and the piercing element extends into the liquid storage cavity through the communication channel; and the communication channel is provided with an inner side wall, and the gap is formed between an outer wall of the piercing element and the inner side wall of the communication channel.

In an aspect, the sealing structure extends in the circumferential direction of the inner side wall of the communication channel to surround the piercing element.

In an aspect, a guiding surface is formed at the side of the sealing structure facing away from the liquid storage cavity; and

in an insertion direction of the piercing element, the guiding surface extends obliquely toward the liquid storage cavity from a side edge thereof connected to the inner side wall of the communication channel to a side edge thereof away from the inner side wall of the communication channel.

In an aspect, the piercing element is provided with a liquid flowing channel inside, and when the piercing element pierces the sealing cover, the liquid storage cavity and the heating assembly are in fluid communication through the liquid flowing channel.

In an aspect, a channel wall of the liquid flowing channel is provided with at least one liquid guiding groove, the at least one liquid guiding groove are spaced apart circumferentially, and each of the at least one liquid guiding groove extends in the length direction of the liquid flowing channel.

In an aspect, a piercing portion extending into the liquid flowing channel protrudes from the end portion of the piercing element inserted into the liquid storage cavity.

In an aspect, a piercing surface extending obliquely relative to an insertion direction of the piercing element is formed at the end of the piercing element inserted into the liquid storage cavity, and the piercing portion is connected to the region of the piercing surface closest to the sealing cover.

In the atomizer, because the outer diameter of the piercing element is smaller than the outer diameter of a pierced structure, after the piercing element pierces the pierced structure, the piercing element is in clearance fit with the sealing cover and the friction is relatively small. Therefore, the user can easily separate the liquid storage assembly and the heating assembly to replace the liquid storage assembly, thereby effectively improving the user experience. In addition, because the gap between the sealing cover and the piercing element is closed by the sealing structure, the atomization substrate in the liquid storage cavity can be effectively prevented from flowing out between the sealing cover and the piercing element. Therefore, insertion and removal of the liquid storage assembly can be convenient, and leakage of the atomization substrate can be prevented, thereby improving the reliability of the atomizer.

### BRIEF DESCRIPTION OF THE DRAWINGS

The accompanying drawings constituting a part of this disclosure are intended to provide further understanding of the present disclosure. Examples of the present disclosure and the description thereof are used for explaining the present disclosure and do not constitute any inappropriate limitation to the present disclosure.

To describe the technical solutions in aspects of the present disclosure more clearly, the following briefly describes the accompanying drawings required for describing the aspects. Apparently, the accompanying drawings in the following description show merely some aspects of the present disclosure, and a person of ordinary skill in the art may still derive other drawings from these accompanying drawings without creative efforts.

FIG. 1 is a schematic diagram of an appearance of an electronic atomization device according to an aspect of this disclosure.

FIG. 2 is a schematic assembly diagram of a liquid storage assembly and a heating assembly of an atomizer according to an aspect of this disclosure.

FIG. 3 is a schematic diagram of an internal structure of an atomizer according to an aspect of this disclosure.

FIG. 4 is a partial enlarged view of a part A of the atomizer shown in FIG. 2.

FIG. 5 is a partial enlarged view of a part B of the atomizer shown in FIG. 3.

FIG. 6 is a schematic exploded view of an atomizer according to an aspect of this disclosure.

FIG. 7 is a schematic structural diagram of a heating top cover and a piercing element of an atomizer according to an aspect of this disclosure.

FIG. 8 is a schematic exploded view of a sealing cover of an atomizer according to an aspect of this disclosure.

FIG. 9 is a schematic assembly diagram of a sealing cover of an atomizer according to an aspect of this disclosure.

### DESCRIPTION OF REFERENCE NUMERALS

1000. electronic atomization device; 100. atomizer; 100a. liquid flowing channel; 120. liquid storage assembly; 120a. liquid storage cavity; 121. housing; 1212. main housing; 1214. exhaust pipe; 1214a. exhaust channel; 123. sealing cover; 122. cover body; 1221. first cover body; 1223. second cover body; 122a. atomization channel; 122b. communication hole; 124. sealing element; 1241. sealing body; 1241a. first sealing portion; 1241b. second sealing portion; 1241c. third sealing portion; 1243. pierced structure; 1245. sealing structure; 1245a. guiding surface; 123a. communication channel; 140. heating assembly; 141. piercing element; 141b. liquid guiding groove; 1412. piercing portion; 143. heating top cover; 145. heating base; 147. atomization core; 140a. atomization cavity; 200. power supply component.

### DETAILED DESCRIPTION

To make the foregoing objectives, features, and advantages of this disclosure more comprehensible, detailed description is provided to specific implementations of this disclosure below with reference to the accompanying drawings. In the following description, many specific details are described for thorough understanding of this disclosure. However, this disclosure may be implemented in many other manners different from those described herein. A person skilled in the art may make similar improvements without departing from the connotation of this disclosure. Therefore, this disclosure is not limited to the examples disclosed below.

In the description of this disclosure, it should be understood that, if the terms such as "center", "longitudinal", "transverse", "length", "width", "thickness", "upper", "lower", "front", "rear", "left", "right", "vertical", "horizontal", "top", "bottom", "inner", "outer", "clockwise", "counterclockwise", "axial", "radial", and "circumferential" appear, orientation or position relationships indicated by the terms are orientation or position relationship shown based on the accompanying drawings, and are merely used for describing this disclosure and simplifying the description, rather than indicating or implying that the mentioned apparatus or element should have a particular orientation or be constructed and operated in a particular orientation, and therefore, should not be construed as a limitation to this disclosure.

In addition, if the terms "first" and "second" appear, the terms are used for descriptive purposes only and are not to be construed as indicating or implying relative importance or implicitly indicating the quantity of technical features indicated. Therefore, a feature restricted by "first" or "second" may explicitly indicate or implicitly include at least one of such features. In the description of this disclosure, if the term "plurality of" appear, "plurality of" means at least two, such as two and three, unless otherwise explicitly and specifically defined.

In this disclosure, unless otherwise explicitly specified and defined, if terms such as "mounted", "connected", "connection", and "fixed" appear, the terms should be understood in a broad sense. For example, the connection may be a fixed connection, a detachable connection, or an integral connection; may be a mechanical connection or an electrical connection; may be a direct connection or an indirect connection by means of an intermediate medium; or may be internal communication between two elements or an interaction relationship between two elements, unless otherwise clearly limited. A person of ordinary skill in the art may understand meanings of the foregoing terms in this disclosure accordingly.

In this disclosure, unless otherwise explicitly specified and defined, if descriptions such as a first feature "on" or "below" a second feature appear, it may mean that the first feature and the second feature are in direct contact, or the first feature and the second feature are in indirect contact through an intermediate medium. In addition, that the first feature is "above", "over", or "on" the second feature may indicate that the first feature is directly above or obliquely above the second feature, or may merely indicate that a horizontal height of the first feature is higher than that of the second feature. That the first feature is "below", "under", and "beneath" the second feature may indicate that the first feature is directly below or obliquely below the second feature, or may merely indicate that the horizontal height of the first feature is lower than that of the second feature.

It should be noted that, if an element is referred to as "being fixed to" or "being arranged on" another element, the element may be directly on the another element, or an intermediate element may be present. If an element is considered to be "connected to" another element, the element may be directly connected to the another element, or an intermediate element may also be present. If exist, the terms "vertical", "horizontal", "upper", "lower", "left", "right", and similar expressions used in this disclosure are only for purposes of illustration but not indicate a unique implementation.

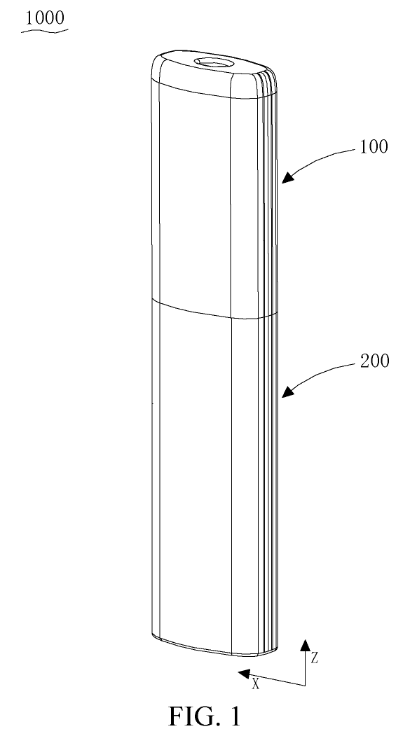

Referring to FIG. 1, an aspect of this disclosure provides an electronic atomization device 1000, configured to atomizing an atomization substrate to generate an aerosol for a user to use. The atomization substrate includes, but not limited to, liquid materials such as medicinal liquids and oils used for medical care, health preservation, health, and cosmetology purposes. The atomization manner includes, but not limited to, resistive heating, electromagnetic heating, infrared heating, laser heating, or microwave heating.

In the following aspects, the height direction of the electronic atomization device 1000 is defined as a first direction (that is, a direction Z in FIG. 1), the length direction of the electronic atomization device 1000 is defined as a second direction (that is, a direction X in FIG. 1), and the first direction intersects with the second direction. In an aspect, the first direction is perpendicular to the second direction.

The electronic atomization device 1000 includes an atomizer 100 and a power supply component 200. The power supply component 200 is fitted to the end of the atomizer 100 in the first direction and is electrically connected to the atomizer 100. The atomizer 100 is configured to store an atomization substrate, and heat and atomize the atomization substrate under the action of electrical energy of the power supply component 200.

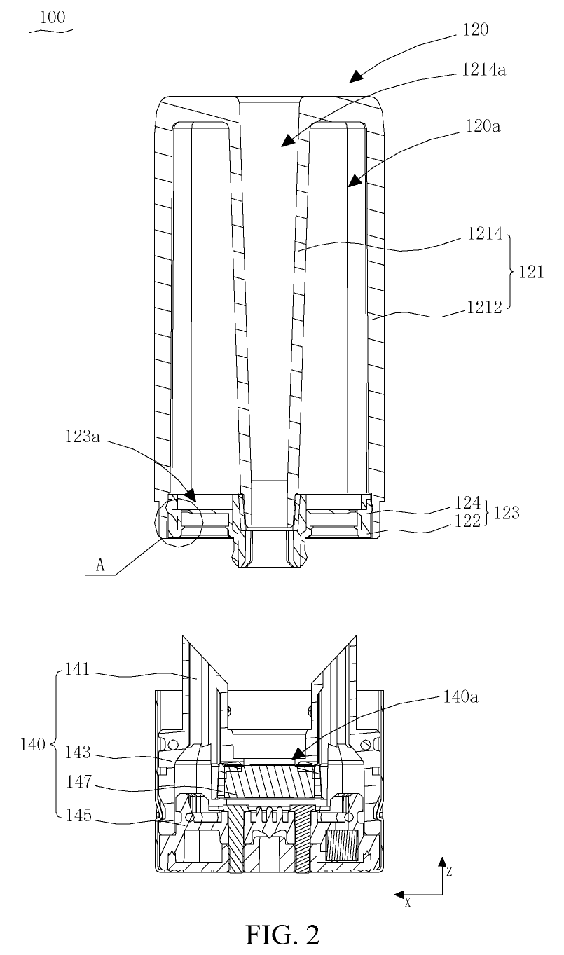

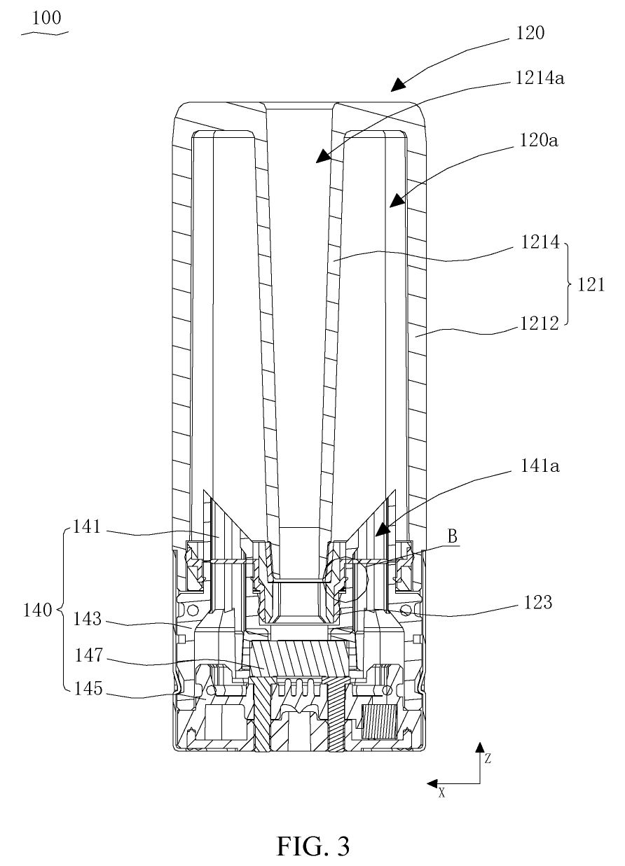

As shown in FIGS. 2 and 3, the atomizer 100 includes a liquid storage assembly 120 and a heating assembly 140. The liquid storage assembly 120 is configured to store the atomization substrate. The heating assembly 140 may be fitted to an end of the liquid storage assembly 120 and pierce the liquid storage assembly 120. The atomization substrate in the liquid storage assembly 120 may flow into the heating assembly 140 and then be heated and atomized by the heating assembly 140 to generate an aerosol. In the following examples, the heating assembly 140 is detachably connected to the liquid storage assembly 120. After the atomization substrate in the liquid storage assembly 120 is completely consumed, the user may replace the liquid storage assembly 120 with a new one, while the heating assembly 140 may be reused.

The liquid storage assembly 120 includes a housing 121 and a sealing cover 123 arranged at an end of the housing 121, and a liquid storage cavity 120a for storing the atomization substrate is formed between the housing 121 and the sealing cover 123. The heating assembly 140 is fitted to the end of the liquid storage assembly 120 at which the sealing cover 123 is arranged. The heating assembly 140 includes a piercing element 141, and the piercing element 141 is configured to pierce the sealing cover 123 to form fluid communication between the liquid storage cavity 120a and the heating assembly 140. Therefore, the atomization substrate in the liquid storage cavity 120a may flow into the heating assembly 140.

Referring to FIG. 2, when the liquid storage assembly 120 is not fitted to the heating assembly 140, the sealing cover 123 may seal the housing 121, to prevent leakage of the atomization substrate in the liquid storage cavity 120a. Referring to FIG. 3, when the liquid storage assembly 120 and the heating assembly 140 are fitted to each other, the piercing element 141 of the heating assembly 140 may pierce the sealing cover 123, and the atomization substrate in the liquid storage cavity 120a may enter the liquid storage cavity 120a to supply liquid to the heating assembly 140.

As described in the BACKGROUND, the liquid storage assembly 120 and the heating assembly 140 are generally fitted to each other in an interference fit manner, to prevent the atomization substrate in the liquid storage cavity 120a from leaking through the gap between the two components. However, this also results in a relatively large friction between the liquid storage assembly 120 and the heating assembly 140, which makes it inconvenient to disassemble and assemble the liquid storage assembly 120 and the heating assembly 140, and easily leads to leakage of the atomization substrate during disassembly, consequently affecting the user experience.

To resolve the foregoing technical problems, referring to FIGS. 2-5, in this disclosure, a gap h is provided between an outer edge of the piercing element 141 and the sealing cover 123. The liquid storage assembly 120 further includes a sealing structure 1245, and the sealing structure 1245 is configured to close the gap between the sealing cover 123 and the piercing element 141.

The sealing cover 123 and the sealing structure 1245 may be separate structures or an integral structure.

Therefore, because the gap h is provided between the outer edge of the piercing element 141 and the sealing cover 123, after the piercing element 141 pierces the sealing cover 123, the outer edge of the piercing element 141 is in clearance fit with the sealing cover 123 and the friction is relatively small. Therefore, the user can easily separate the liquid storage assembly 120 and the heating assembly 140 to replace the liquid storage assembly 120, thereby effectively improving the user experience. In addition, because the gap h between the sealing cover 123 and the piercing element 141 is closed by the sealing structure 1245, the atomization substrate in the liquid storage cavity 120a can be effectively prevented from flowing out through the gap h. Therefore, insertion and removal of the liquid storage assembly 120 can be convenient, and leakage of the atomization substrate can be prevented, thereby improving the reliability of the atomizer 100.

It should be noted that in the foregoing example, the atomizer 100 and the power supply component 200 are arranged in the first direction, and the piercing element 141 pierces the sealing cover 123 in the first direction. That is, the direction in which the piercing element 141 pierces the sealing cover 123 is parallel to the first direction, and the first direction is the height direction of the electronic atomization device 1000. In other examples, the atomizer 100 and the power supply component 200 may alternatively be arranged in a direction perpendicular to the first direction, and in this case, the direction in which the piercing element 141 pierces the sealing cover 123 is perpendicular to the first direction. That is, the direction in which the piercing element 141 pierces the sealing cover 123 is perpendicular to the height direction of the electronic atomization device 1000.

Further, the sealing cover 123 is provided with a communication channel 123a, and the piercing element 141 extends into the liquid storage cavity 120a through the communication channel 123a. The communication channel 123a is provided with an inner side wall, and the gap h is formed between an outer wall of the piercing element 141 and the inner side wall of the communication channel 123a.

Therefore, when the liquid storage assembly 120 is not fitted to the heating assembly 140, the communication channel 123a is in a closed state. When the liquid storage assembly 120 and the heating assembly 140 are fitted to each other, the piercing element 141 extends into the liquid storage cavity 120a through the communication channel 123a, and the sealing structure 1245 closes the gap h, to prevent leakage of the atomization substrate.

In an aspect, the sealing structure 1245 and a pierced surface of the sealing cover 123 are arranged sequentially in the first direction. The sealing structure 1245 is located at the side of the pierced surface away from the liquid storage cavity 120a, thereby being configured to receive the atomization substrate that may leak from the gap h, thereby effectively preventing the atomization substrate from leaking to the outside of the atomizer 100.

In an aspect, as shown in FIG. 2, the housing 121 includes a main housing 1212 and an exhaust pipe 1214. The main housing 1212 has a hollow housing structure, and is provided with an open end and a closed end opposite to each other in the first direction. One end of the exhaust pipe 1214 is connected to the closed end of the main housing 1212, and the other end of the exhaust pipe 1214 extends toward the open end of the main housing 1212 in the first direction. An exhaust channel 1214a is formed inside the exhaust pipe 1214. The exhaust channel 1214a runs through the closed end of the exhaust pipe 1214 to be in communication with the external air. The liquid storage cavity 120a surrounds the exhaust pipe 1214 circumferentially.

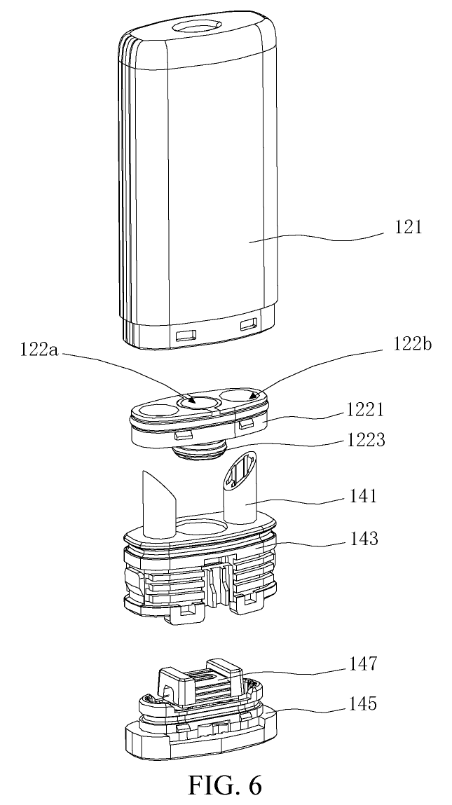

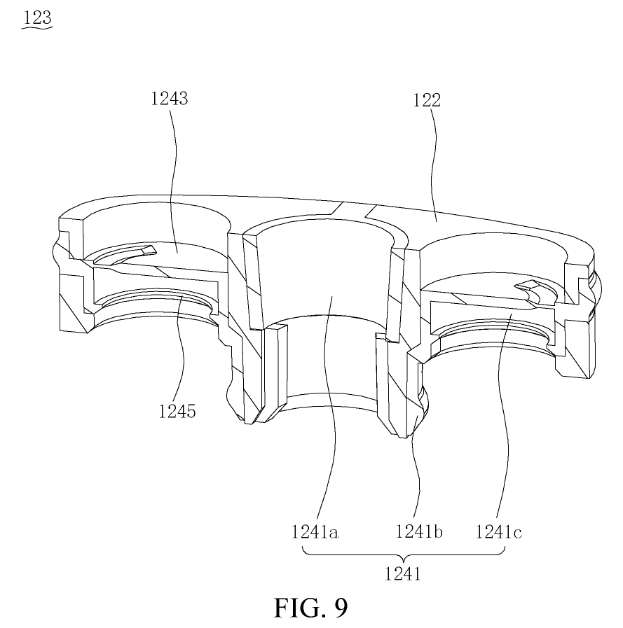

Referring to FIGS. 2, 3, 6, 8, and 9, the sealing cover 123 includes a cover body 122 and a sealing element 124 embedded in the cover body 122.

The cover body 122 includes a first cover body 1221 and a second cover body 1223. The shape of the first cover body 1221 matches the shape of the open end of the main housing 1212, thereby being fitted in the open end of the main housing 1212. The second cover body 1223 is connected to the center position of one side of the first cover body 1221 and protrudes out of the main housing 1212, and the outer diameter of the second cover body 1223 is smaller than the outer diameter of the first cover body 1221.

The cover body 122 is provided with an atomization channel 122a and two communication holes 122b. The atomization channel 122a is formed at the center position of the sealing cover 123 and runs through the first cover body 1221 and the second cover body 1223 in the first direction. One end of the exhaust pipe 1214 of the housing 121 is inserted into the atomization channel 122a located in the first cover body 1221 in the first direction, for the exhaust channel 1214a to be in communication with the atomization channel 122a. The two communication holes 122b are formed in the first cover body 1221 and are respectively located on opposite sides of the atomization channel 122a in the second direction. It may be understood that, in some other examples, the quantity and arrangement positions of the communication holes 122b are not limited thereto. In one example, the sealing cover 123 may be provided with only one communication hole 122b.

The sealing element 124 is formed by a flexible material such as silicone, and includes a sealing body 1241, a pierced structure 1243, and the sealing structure 1245 that are interconnected and integrally formed.

Specifically, the sealing body 1241 includes a first sealing portion 1241a, a second sealing portion 1241b, and a third sealing portion 1243. The first sealing portion 1241a circumferentially covers the inner side wall of the atomization channel 122a located in the first cover body 1221. The second sealing portion 1241b circumferentially covers the outer side wall of the second cover body 1223. The third sealing portion 1241c is located in the communication hole 122b. The third sealing portion 1241c circumferentially surrounds the middle region of the hole wall of the communication hole 122b. The communication channel 123a is jointly defined and formed by the third sealing portion 1241c and the communication hole 122b. The inner side wall of the third sealing portion 1241c and the hole wall of the communication hole 122b not covered by the third sealing portion 1241c jointly form the inner side wall of the communication channel 123a.

The pierced structure 1243 is arranged at the end portion of the third sealing portion 1241c close to the liquid storage cavity 120a. The pierced structure 1243 completely covers the open end of the third sealing portion 1241c, to close the communication channel 123a. When the liquid storage assembly 120 is not fitted to the heating assembly 140, the pierced structure 1243 closes the communication channel 123a, to keep the liquid storage cavity 120a in a sealed state to prevent leakage of the atomization substrate. After the piercing element 141 pierces the pierced structure 1243, at least a part of the edge of the pierced structure 1243 is separated from the third sealing portion 1241c, to open the communication channel 123a. An outer edge of the pierced structure 1243 is the outer edge of the foregoing sealing cover 123. In a preferable implementation, the thickness of a part of the edge of the pierced structure 1243 is less than the thicknesses of other regions of the pierced structure, thereby providing relatively low strength, to facilitate piercing by the piercing element 141.

The sealing structure 1245 is formed in the end of the third sealing portion 1241c away from the pierced structure 1243. The sealing structure 1245 extends in the circumferential direction of the inner wall of the third sealing portion 1241c to surround the piercing element 141, thereby being configured to close the gap h between the piercing element 141 and the inner side wall of the communication channel 123a. Therefore, the sealing structure 1235 forms an annular sealing ring around the inner side wall of the communication channel 123a. The sealing structure 1235 is in interference fit with the piercing element 141, thereby being capable of sealing various regions around the piercing element 141 and ensuring that the atomization substrate in the liquid storage cavity 120a cannot leak through the gap h. Because the sealing cover 123 is in contact with the piercing element 141 only through the sealing structure 1235, the contact area between the two components is relatively small. Therefore, no excessively large friction will be generated to affect the smoothness of disassembly and assembly of the liquid storage assembly 120 and the heating assembly 140. In an aspect, the shape of the sealing structure 1235 may be set as required, to meet different sealing requirements.

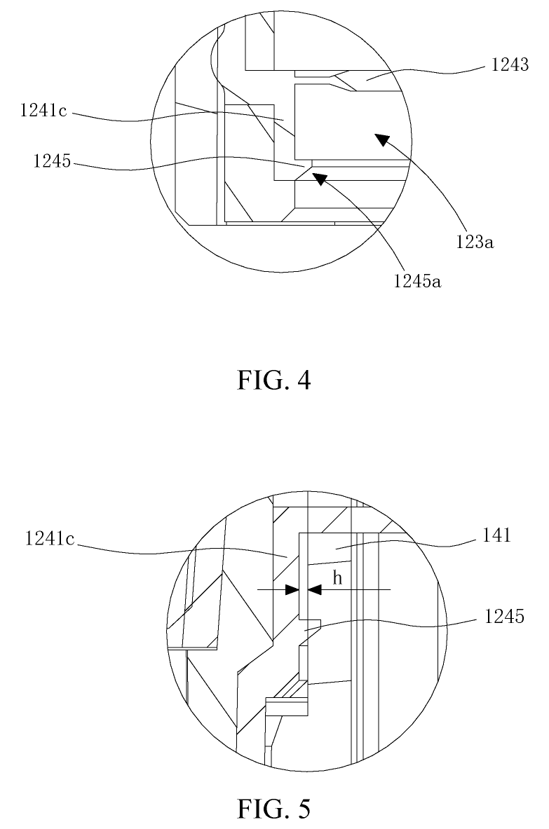

In a preferable implementation, as shown in FIG. 4, a guiding surface 1245a is formed at the side of the sealing structure 1235 facing away from the liquid storage cavity 120a. In an insertion direction of the piercing element 141, the guiding surface 1245a extends obliquely toward the liquid storage cavity 120a from a side edge thereof connected to the inner side wall of the communication channel 123a to a side edge thereof away from the inner side wall of the communication channel 123a, thereby being a conical surface. The guiding surface 1245a guides the piercing element 141 to pierce the pierced structure 1243, so that the piercing element 141 successfully pierces the pierced structure 1243 to enter the liquid storage cavity 120a. It may be understood that, the shape of the guiding surface 1245a is not limited thereto, and may be set as required to meet different requirements.

It may be understood that, the quantity of sealing structures 1235 is not limited. In an aspect, the sealing cover 123 is provided with only one annular sealing structure 1235. In an aspect, the sealing cover 123 may alternatively include a plurality of sealing structures 1235. All the sealing structures 1235 are spaced apart in the axial direction of the inner side wall of the communication channel 123a, thereby forming a plurality of seals to improve the sealing effect.

As shown in FIGS. 2, 5, 6, and 7, in addition to the piercing element 141, the heating assembly 140 further includes a heating top cover 143, a heating base 145, and an atomization core 147.

The heating base 145 is fitted to one end of the heating top cover 143 in the first direction, and an atomization cavity 140a with openings at two ends in the first direction is jointly defined and formed by the heating top cover 143 and the heating base 145. Two piercing elements 141 protrude from the other end of the heating top cover 143 in the first direction, and the two piercing elements 141 are spaced apart in the second direction. It may be understood that, the quantity of piercing elements 141 corresponds to the quantity of communication channels 123a. When the sealing cover 123 is provided with only one communication channel 123a, the heating assembly 140 is also provided with only one corresponding piercing element 141.

The atomization core 147 is accommodated in the atomization cavity 140a, and includes a substrate and a heating element embedded on the surface of the substrate. The substrate is configured to absorb the atomization substrate and guide the atomization substrate to flow to the heating element, and the heating element is configured to heat the atomization substrate to generate an aerosol. It may be understood that, the specific arrangement position of the heating element is not limited. The heating element may be arranged on the upper surface of the substrate facing away from the heating base 145, on the lower surface of the substrate facing the heating base 145, or on the side surface of the substrate.

When the heating assembly 140 and the liquid storage assembly 120 are fitted to each other, the sealing cover 123 and the heating top cover 143 abut against each other in the first direction. The second cover body 1223 of the sealing cover 123 extends into the heating top cover 143 in the first direction. The atomization channel 122a on the sealing cover 123 is in communication with the atomization cavity 140a of the heating assembly 140. Therefore, the aerosol flowing out from the atomization cavity 140a may flow out through the atomization channel 122a and the exhaust channel 1214a in sequence. The two piercing elements 141 respectively pierce the pierced structure 1243 in the first direction and are inserted into the liquid storage cavity 120a.

Because the outer diameter of the piercing element 141 is smaller than the outer diameter of the pierced structure 1243, after the piercing element 141 pierces the pierced structure 1243, a gap h surrounding the piercing element 141 circumferentially is formed between the inner side wall of the communication channel 123a and the piercing element 141. Therefore, the friction between the inner side wall of the communication channel 123a and the piercing element 141 during disassembly and assembly of the heating assembly 140 and the liquid storage assembly 120 can be significantly reduced, making the disassembly and assembly of the heating assembly 140 and the liquid storage assembly 120 smoother. In an aspect, the inner side wall of the communication channel 123a may alternatively be in partial contact with the piercing element 141, thereby reducing the friction between the two components while still providing a certain sealing effect.

In an aspect, each piercing element 141 has a hollow tubular structure, thereby forming a liquid flowing channel 100a extending in the first direction. The liquid flowing channel 100a is configured to form fluid communication between the liquid storage cavity 120a and the heating assembly 140, so that the atomization substrate in the liquid storage cavity 120a can enter the atomization cavity 140a through the liquid flowing channel 100a. It may be understood that, the formation manner of the liquid flowing channel 100a is not limited thereto. In an aspect, the piercing element 141 may alternatively be a solid structure. After the piercing element pierces the pierced structure 1243, a liquid flowing channel 100a is formed on the sealing cover 123.

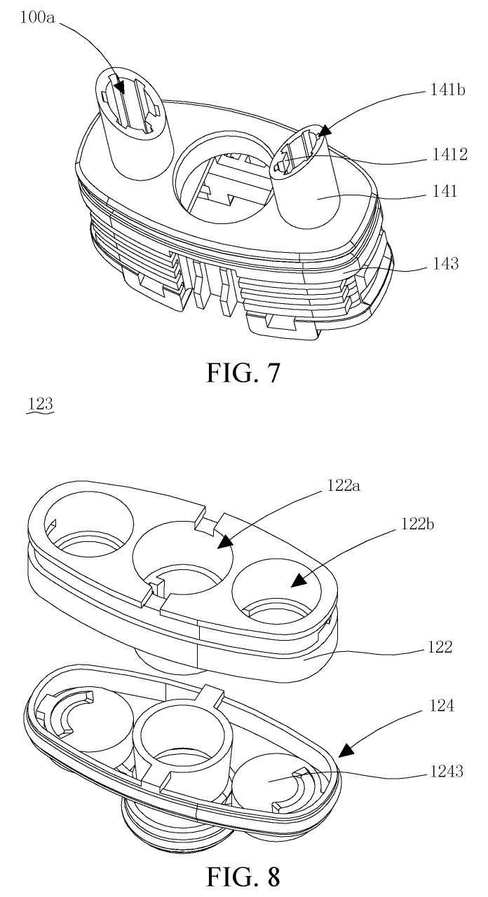

In an aspect, as shown in FIG. 7, channel walls of the liquid flowing channels 100a of the two piercing elements 141 are both provided with liquid guiding grooves 141b. The liquid guiding grooves 141b may form a capillary effect, to guide the atomization substrate in the liquid storage cavity 120a to quickly pass through the narrow space of the liquid flowing channel 100a and reach the atomization cavity 140a, thereby effectively preventing the occurrence of insufficient liquid supply.

The channel wall of the liquid flowing channel 100a is provided with at least one liquid guiding groove 141b, and the at least one liquid guiding groove 141b is spaced apart circumferentially. Each liquid guiding groove 141b extends in the length direction of the liquid flowing channel 100a, thereby forming a good liquid guiding effect. It may be understood that, the quantity, shape, and arrangement manner of the liquid guiding grooves 141b are not limited, and may be set as required to meet liquid flowing requirements.

Further, when the liquid atomization substrate reaches the end of the piercing element 141 inserted into the liquid storage cavity 120a, the atomization substrate generates friction with the piercing element 141 and will form a liquid film that blocks the liquid flowing channel 100a, resulting in a liquid seal phenomenon and preventing normal liquid flowing. For the foregoing problems, in some embodiments, a piercing portion 1412 extending into the liquid flowing channel 100a protrudes from the end portion of the piercing element 141 inserted into the liquid storage cavity 120a. The piercing portion 1412 is configured to pierce the liquid film formed by the atomization substrate, to prevent the liquid seal phenomenon, so that the liquid can smoothly enter the liquid flowing channel 100a. It may be understood that, the shape and the quantity of piercing portions 1412 are not limited, and may be set as required to achieve a good piercing effect.

In an aspect, the end of the piercing element 141 inserted into the liquid storage cavity 120a extends obliquely, thereby forming a piercing surface extending obliquely relative to the insertion direction of the piercing element 141, to facilitate piercing the pierced structure 1243. The piercing portion 1412 is connected to the region of the piercing surface closest to the sealing cover 123 (that is, the lowest part of the piercing surface), thereby achieving a better piercing effect. It may be understood that, the position of the piercing portion 1412 is not limited thereto, and the piercing portion may alternatively be located at other positions on the piercing surface.

In the atomizer 100 and the electronic atomization device 1000 including the atomizer 100, through the configuration of the gap h between the outer edge of the piercing element 141 and the sealing cover 123, excessively large friction caused by interference fit between the piercing element 141 and the sealing cover 123 can be avoided, thereby facilitating insertion and removal of the liquid storage assembly 120 and the heating assembly 140 easier; and through the configuration of the sealing structure 1235, leakage of the atomization substrate through the gap h during insertion and removal of the liquid storage assembly 120 and the heating assembly 140 can be prevented. In addition, improvements on the piercing element 141 make the atomization substrate flow more smoothly, thereby effectively preventing phenomena such as dry heating caused by insufficient liquid supply to the atomization core 147.

Various technical features in the foregoing examples may be combined randomly. For a concise description, possible combinations of various technical features in the foregoing examples are not all described. However, the combinations of the technical features are to be considered as falling within the scope recorded in this specification provided that the combinations of the technical features do not conflict with each other.

The foregoing examples show only several implementations of this disclosure and are described in detail, which, however, are not to be construed as a limitation to the patent scope of this disclosure. For a person of ordinary skill in the art, several transformations and improvements can be made without departing from the idea of this disclosure, which all fall within the protection scope of this disclosure. Therefore, the protection scope of this disclosure is subject to the protection scope of the appended claims.

What is claimed is:

1. An atomizer comprising:
a liquid storage assembly including a housing and a sealing cover arranged at an end of the housing;
a liquid storage cavity being formed between the housing and the sealing cover;
a heating assembly including at least one piercing element, and the at least one piercing element is configured to pierce the sealing cover to form fluid communication between the liquid storage cavity and the heating assembly;
a gap being provided between an outer edge of the at least one piercing element and the sealing cover; and
a sealing structure being provided to seal the gap between the sealing cover and the piercing element.

2. The atomizer of claim 1, wherein in a direction the at least one piercing element pierces the sealing cover, the sealing structure and a pierced surface of the sealing cover are arranged sequentially, and the sealing structure is located at a side of the pierced surface away from the liquid storage cavity.

3. The atomizer of claim 1, the sealing cover further comprising:
a communication channel including an inner side wall, and the gap is formed between an outer wall of the at least one piercing element and the inner side wall of the communication channel.

4. The atomizer of claim 3, wherein the sealing structure extends in a circumferential direction of the inner side wall of the communication channel to surround the at least one piercing element.

5. The atomizer of claim 3, further comprising:
a guiding surface being formed at a side of the sealing structure facing away from the liquid storage cavity; and
the guiding surface extending toward the liquid storage cavity and connecting the inner side wall of the communication channel.

6. The atomizer of claim 1, further comprising:
a liquid flowing channel, the liquid storage cavity and the heating assembly are in fluid communication through the liquid flowing channel.

7. The atomizer of claim 6, the liquid flowing channel further comprising:
at least one liquid guiding groove being spaced apart circumferentially, and the at least one liquid guiding groove extending in a length direction of the liquid flowing channel.

8. The atomizer of claim 6, wherein an end portion of the at least one piercing element is inserted into the liquid storage cavity.

9. The atomizer of claim 8, further comprising:
a piercing surface being formed at the end portion of the at least one piercing element inserted into the liquid storage cavity.

10. An electronic atomization device comprising:
a power supply component;
an atomizer including:
a liquid storage assembly including a housing and a sealing cover arranged at an end of the housing,
a liquid storage cavity being formed between the housing and the sealing cover,
a heating assembly including at least one piercing element, and the at least one piercing element is configured to pierce the sealing cover to form fluid communication between the liquid storage cavity and the heating assembly,
a gap being provided between an outer edge of the at least one piercing element and the sealing cover, and
a sealing structure being provided to seal the gap between the sealing cover and the piercing element; and
wherein the power supply component is configured to supply power to the atomizer.

11. The atomizer of claim 10, wherein in a direction the at least one piercing element pierces the sealing cover, the sealing structure and a pierced surface of the sealing cover are arranged sequentially, and the sealing structure is located at the side of the pierced surface away from the liquid storage cavity.

12. The atomizer of claim 10, the sealing cover further comprising:
a communication channel including an inner side wall, and the gap is formed between an outer wall of the at least one piercing element and the inner side wall of the communication channel.

13. The atomizer of claim 10, wherein the sealing structure extends in the circumferential direction of the inner side wall of the communication channel to surround the at least one piercing element.

14. The atomizer of claim 12, further comprising:
a guiding surface being formed at the side of the sealing structure facing away from the liquid storage cavity; and
the guiding surface extending toward the liquid storage cavity and connecting the inner side wall of the communication channel.

15. The atomizer of claim 10, further comprising:
a liquid flowing channel, the liquid storage cavity and the heating assembly are in fluid communication through the liquid flowing channel.

16. The atomizer of claim 15, the liquid flowing channel further comprising:
at least one liquid guiding groove being spaced apart circumferentially, and the at least one liquid guiding groove extending in the length direction of the liquid flowing channel.

17. The atomizer of claim 15, wherein an end portion of the at least one piercing element is inserted into the liquid storage cavity.

18. The atomizer of claim 17, further comprising:
a piercing surface being formed at the end portion of the at least one piercing element inserted into the liquid storage cavity.
